(19) United States
(12) Patent Application Publication
(10) Pub. No.: US 2022/0290828 A1
(43) Pub. Date: Sep. 15, 2022

(54) LASER-ASSIST LED FOR HIGH-POWER ADB AUTOMOTIVE HEADLIGHT

(71) Applicant: Optonomous Technologies, Inc., Agoura Hills, CA (US)

(72) Inventors: Kenneth Li, Agoura Hills, CA (US); Yung Peng Chang, Hsinchu (TW)

(21) Appl. No.: 17/693,384

(22) Filed: Mar. 13, 2022

Related U.S. Application Data
(60) Provisional application No. 63/294,808, filed on Dec. 29, 2021.
(60) Provisional application No. 63/160,676, filed on Mar. 12, 2021.

(51) Int. Cl. F21S 41/16; G03B 21/20; F21S 41/14; F21S 41/141; F21S 41/40; F21K 9/64

(52) U.S. Cl. CPC F21S 41/16; G03B 21/204; F21S 41/18; F21S 41/141; F21S 41/40; F21K 9/64; F21Y 2115/10

(57) ABSTRACT

An adaptive-driving-beam (ADB) headlight including a white LED having an emission area; an optional single-crystal-phosphor (SCP) plate mounted over a portion of the emission area; and, optionally, at least one laser that emits a blue laser beam that impinges on the SCP plate such that the SCP plate wavelength converts at least some of the light of the blue laser beam and at least some of the light of the white LED to longer wavelengths than wavelengths of the light of the blue laser beam and the light of the white LED. Some embodiments further include a projection lens; a curved mirror to reflect and focus light from the SCP and/or white LED towards a digital-mirror device (DMD), configured to selectively reflect the received light toward the projection lens, in order to provide increased field of view (FOV) and headlight brightness.

### CROSS-REFERENCE TO RELATED APPLICATIONS

This application claims priority benefit, under 35 U.S.C. §119(e), of U.S. Provisional Patent Application No. 63/160,676 filed Mar. 12, 2021 by Kenneth Li, titled “Laser-assist LED for high-power ADB automotive headlight,” and U.S. Provisional Patent Application No. 63/294,808 filed Dec. 29, 2021 by Kenneth Li and Yung Peng Chang, titled “Laser-assist LED light source using DMD as a reflector for high-power ADB automotive headlight,” each of which is incorporated herein by reference in its entirety.

This application is related to:
U.S. national-stage patent application Ser. No. 17/613,916 by Y. P. Chang et al. (from prior Application PCT/US2020/034447—published Dec. 3, 2020 as WO 2020/243038) titled “LiDAR integrated with smart headlight and method,” PCT filing date: May 24, 2020, U.S. filing date: Nov. 23, 2021;
U.S. Provisional Patent Application No. 62/853,538, filed May 28, 2019 by Y. P. Chang et al., titled “LIDAR integrated with smart headlight using a single DMD”;
U.S. Provisional Patent Application No. 62/857,662, filed Jun. 5, 2019 by Chun-Nien Liu et al., titled “Scheme of LIDAR-embedded smart laser headlight for autonomous driving”;
U.S. Provisional Patent Application No. 62/950,080, filed Dec. 18, 2019 by Kenneth Li, titled “Integrated LIDAR and smart headlight using a single MEMS mirror”;
PCT Patent Application PCT/US2019/037231 titled “Illumination system with high intensity output mechanism and method of operation thereof,” filed Jun. 14, 2019 by Y. P. Chang et al. (published Jan. 16, 2020 as WO 2020/013952);
U.S. patent application Ser. No. 16/509,085 titled “Illumination system with crystal phosphor mechanism and method of operation thereof,” filed Jul. 11, 2019 by Y. P. Chang et al. (published Jan. 23, 2020 as US 2020/0026169);
U.S. patent application Ser. No. 16/509,196 titled “Illumination system with high intensity projection mechanism and method of operation thereof,” filed Jul. 11, 2019 by Y. P. Chang et al. (published Jan. 23, 2020 as US 2020/0026170);
U.S. Provisional Patent Application 62/837,077 titled “LASER excited crystal phosphor sphere light source,” filed Apr. 22, 2019 by Kenneth Li et al.;
U.S. Provisional Patent Application 62/853,538 titled “LiDAR integrated with smart headlight using a single DMD,” filed May 28, 2019 by Y. P. Chang et al.;
U.S. Provisional Patent Application 62/856,518 titled “Vertical cavity surface emitting laser using dichroic reflectors,” filed Jul. 8, 2019 by Kenneth Li et al.;
U.S. Provisional Patent Application 62/871,498 titled “Laser-excited phosphor light source and method with light recycling,” filed Jul. 8, 2019 by Kenneth Li;
U.S. Provisional Patent Application 62/857,662 titled “Scheme of LiDAR-embedded smart laser headlight for autonomous driving,” filed Jun. 5, 2019 by Chun-Nien Liu et al.;
U.S. Provisional Patent Application 62/873,171 titled “Speckle reduction using moving mirrors and retro-reflectors,” filed Jul. 11, 2019 by Kenneth Li;
U.S. Provisional Patent Application 62/862,549 titled “Enhancement of LED intensity profile using laser excitation,” filed Jun. 17, 2019 by Kenneth Li;
U.S. Provisional Patent Application 62/874,943 titled “Enhancement of LED intensity profile using laser excitation,” filed Jul. 16, 2019 by Kenneth Li;
U.S. Provisional Patent Application 62/881,927 titled “System and method to increase brightness of diffused light with focused recycling,” filed Aug/ 1, 2019 by Kenneth Li;
U.S. Provisional Patent Application 62/895,367 titled “Increased brightness of diffused light with focused recycling,” filed Sep. 3, 2019 by Kenneth Li;
U.S. Provisional Patent Application 62/903,620 titled “RGB laser light source for projection displays,” filed Sep. 20, 2019 by Lion Wang et al.; and
PCT Patent Application PCT/US2020/037669, filed Jun. 14, 2020 by Kenneth Li et al. and titled “Hybrid LED/laser light source for smart headlight applications” (published Dec. 24, 2020 as WO 2020/257091); each of which is incorporated herein by reference in its entirety.

### FIELD OF THE INVENTION

The present invention relates to the field of solid-state illumination, and more specifically to a system and method for using a single-mirror micro-electrical-mechanical system (MEMS) scanning mirror assembly, and/or a DMD (digital micromirror device) having a plurality of independently steerable mirrors or switchable-tilt mirrors for steering a plurality of light beams that include one or more light beam(s) for the headlight beam(s) of a vehicle, along with highly effective associated devices for light-wavelength conversion, light dumping and/or heatsinking.

### BACKGROUND OF THE INVENTION

Vehicle headlights are becoming “smarter” and “more intelligent.” The safety features of the headlight are very critical, especially when a vehicle is driven at night or in bad weather. The design of vehicle headlights should meet performance requirements and strict automotive and highway-safety standards, such as those of the United Nations Economic Commission for Europe (ECE). Adaptive-driving-beam (ADB) headlights have been approved as one of the advanced headlamp technologies. Recently, ADB headlights have been developed using blue-light-emitting diode (LED) arrays with a wavelength-converting silicone-based phosphor, a digital micromirror device (DMD), and a projection lens. Although LED technology dominates the automotive market due to its high efficiency, high reliability, long lifetime, and smaller dimensions, which are ideal to save space in headlamps, the electrical-to-light power-conversion efficiency of LEDs drops with the increase of input-power density. This is a drawback of LED technology to be used in high-power applications, such as automotive headlamps. Furthermore, the nearly-Lambertian light-emission pattern of LEDs limits the optical system efficiency. Therefore, it is necessary to develop an ADB headlight with a Laser-Assist™ LED system, which can increase the field-of-view (FOV) and the brightness of the headlight. However, due to thermal-stability problems caused by silicone-based phosphor, the degradation of silicone resins due to heating from the blue-light source adversely affects the overall optical properties and chromaticity characteristics of the white-light source.

Therefore, there is a need for alternative matrix materials with high thermal stability for ADB headlights with a Laser-Assist™ LED system. There is also a need in the art for an improved smart headlight and method, and a combined vehicle smart headlight and LiDAR system and method.

### SUMMARY OF THE INVENTION

In some embodiments, the present invention provides an apparatus that includes: a laser-pumped clear phosphor plate and/or LED; a DMD having a plurality of individually selectable mirrors arranged on a first major surface of the DMD; first optics configured to capture light from the DMD, wherein each respective one of the plurality of mirrors of the DMD is switchable to selectively reflect a respective portion of the captured light to one of a plurality of angles including a first angle that directs the reflected light toward the light detector and a second angle that directs the reflected light toward the first light dump. In some embodiments, the output beam is used as an adaptive driving beam (ADB) headlight for a vehicle.

### BRIEF DESCRIPTION OF THE DRAWINGS

FIG. 1 is a side-view cross-section view of a laser-pumped crystal-phosphor plate light source 101, according to some embodiments of the present invention.

FIG. 2A is a side-view cross-section view of a combined LED and laser-pumped crystal-phosphor plate light source 201, according to some embodiments of the present invention.

FIG. 2B is a top-view a combined LED and laser-pumped crystal-phosphor plate light source 202, according to some embodiments of the present invention.

FIG. 2C is a top-view a combined LED and laser-pumped crystal-phosphor plate light source 203, according to some embodiments of the present invention.

FIG. 2D is a top-view a combined LED and laser-pumped crystal-phosphor plate light source 204, according to some embodiments of the present invention.

FIG. 3 is a side cross-section view of a DMD headlight 301 that uses a high-power white LED light source 321, according to some embodiments of the present invention.

FIG. 4 is a side cross-section view of a DMD headlight 401 that uses a high-power white LED light source 421, according to some embodiments of the present invention

FIG. 5 is a side cross-section view of a DMD headlight 501 that uses a combined LED and laser-pumped crystal-phosphor plate light source 521, according to some embodiments of the present invention.

FIG. 6 is a side cross-section view of a DMD headlight 601 that uses a combined LED and laser-pumped crystal-phosphor plate light source 621, according to some embodiments of the present invention.

FIG. 7 is a side cross-section view of an ADB headlight 701 that uses a LED light source 721, according to some embodiments of the present invention.

FIG. 8 is a side cross-section view of an ADB headlight 801 that uses a combined LED and laser-pumped crystal-phosphor plate light source 821, according to some embodiments of the present invention.

FIG. 9A is a side cross-section view of an ADB headlight 901 that uses a combined LED and laser-pumped crystal-phosphor plate light source 921, according to some embodiments of the present invention.

FIG. 9B is a side cross-section view of an ADB headlight 902 that uses a combined LED and laser-pumped crystal-phosphor plate light source 921, according to some embodiments of the present invention.

FIG. 10 is a front-view of a DMD 1001, according to some embodiments of the present invention.

FIG. 11 is a side cross-section view of a DMD headlight 1101 that uses a combined LED and laser-pumped crystal-phosphor plate light source 1123, according to some embodiments of the present invention.

FIG. 12 is a side cross-section view of a DMD headlight 1201 that uses a combined LED and laser-pumped crystal-phosphor plate light source 1223, according to some embodiments of the present invention.

### DESCRIPTION OF PREFERRED EMBODIMENTS

Although the following detailed description contains many specifics for the purpose of illustration, a person of ordinary skill in the art will appreciate that many variations and alterations to the following details are within the scope of the invention. Specific examples are used to illustrate particular embodiments; however, the invention described in the claims is not intended to be limited to only these examples, but rather includes the full scope of the attached claims. Accordingly, the following preferred embodiments of the invention are set forth without any loss of generality to, and without imposing limitations upon the claimed invention. Further, in the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The embodiments shown in the Figures and described here may include features that are not included in all specific embodiments. A particular embodiment may include only a subset of all of the features described, or a particular embodiment may include all of the features described.

The leading digit(s) of reference numbers appearing in the Figures generally corresponds to the Figure number in which that component is first introduced, such that the same reference number is used throughout to refer to an identical component which appears in multiple Figures. Signals and connections may be referred to by the same reference number or label, and the actual meaning will be clear from its use in the context of the description.

Certain marks referenced herein may be common-law or registered trademarks of third parties affiliated or unaffiliated with the applicant or the assignee. Use of these marks is for providing an enabling disclosure by way of example and shall not be construed to limit the scope of the claimed subject matter to material associated with such marks.

Most white-light headlight “engines” are integrated using blue-light LED or laser sources combined with a phosphor wavelength-conversion layer. Conventional phosphor wavelength-conversion layers have been fabricated using silicone-based phosphor, glass-based phosphor, ceramic-based phosphor, or single-crystal-based phosphor. The single-crystal phosphor (SCP) exhibits excellent thermal stability, better conversion efficiency, and high transparency to yellow light, but conventionally requires a high-temperature fabrication process. This high-temperature fabrication process has been difficult for commercial production. Recently, the issues of higher fabrication temperature of the SCP have been overcome by using a novel design of single-crystal growth to produce SCP with higher yield and better uniformity. In the present invention, the ADB headlight includes a white LED, a Texas Instruments (TI) digital-mirror device (DMD), a projection lens, and a Laser-Assist™ LED system. The advantage of introducing the Laser-Assist™ LED system employing ultra-reliable SCP is to produce high intensity of the ADB, which enables an increase in FOV and brightness of the ADB headlight, and results in significant improvement of visibility and illumination distance. The disclosed invention—an ADB headlight with ultra-reliable SCP and Laser-Assist™ LED system—will be one of the most promising ADB headlight candidates for use in the next-generation autonomous vehicle applications.

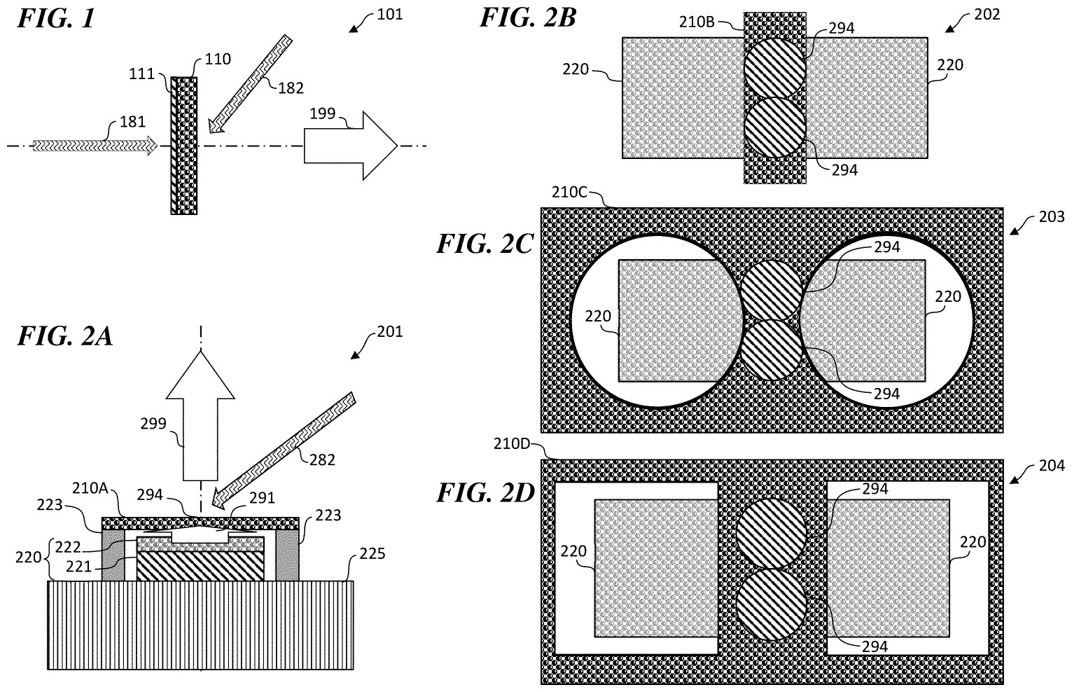

FIG. 1 is a side-view cross-section view of a front-and-back-laser-pumped crystal-phosphor plate light source 101, according to some embodiments of the present invention. In some embodiments, light source 101 includes a crystal-phosphor plate 110 that is pumped from its back side (relative to the output beam 199) with excitation laser beam 181, and pumped from its front side (relative to the output beam 199) with excitation laser beam 182. In some embodiments, crystal-phosphor plate 110 is coated with a yellow-reflective coating on its “back” side (the left side in FIG. 1), so that the yellow output light is emitted from the opposite “front” side. In some embodiments, wavelength-selective coating 111, which transmits the blue wavelengths (e.g., in some embodiments, transmitting blue wavelengths in a wavelength range of about 400 nm to about 500 nm (in some embodiments, within a narrower range of about 405 plus or minus 5 nm, or about 450 plus or minus 5 nm), wherein the wavelength range includes the wavelengths of blue laser light 181), and which reflects yellow wavelengths (e.g., in some embodiments, “yellow” wavelengths in a wavelength range between 500 nm and 700 nm centered at about 580 nm, which is perceived by the human eye as yellow, wherein the wavelength range includes the wavelengths emitted by crystal-phosphor plate 110 when pumped by blue laser light 181), is applied to the “back” side of crystal-phosphor plate 110. In some embodiments, crystal-phosphor plate 110 is made from a single-crystal phosphor (SCP), which is a transparent material that absorbs blue light and emits the absorbed energy from that blue light as wavelength-converted yellow light. As a result, crystal-phosphor plate 110 is an ideal material for wavelength-conversion of blue laser light into yellow visible light, allowing high efficiency, and high-temperature operations. In some embodiments, the SCP is optically polished on both sides. In some other embodiments, only the output surface is roughened or etched, in order to provide specific surface structures to increase output efficiency. The transparent property of the crystal-phosphor material provides advantageous features that are not available in other phosphor materials such as glass phosphor and ceramic phosphor, when the laser energy is all concentrated in a small spot with small thickness, making heat removal very challenging. Together with the residual blue laser light that is not wavelength-converted by crystal-phosphor plate 110, white-light output 199 is produced. The front laser excitation 182, in this case, enhances the output brightness.

FIG. 2A is a side-view cross-section view of a combined LED and laser-pumped crystal-phosphor plate light source 201, according to some embodiments of the present invention. In some embodiments, to capitalize on the advanced developments of the high-brightness LED and the transparent property of the SCP material, laser-assisted LED light source 201 includes an SCP plate 210A that is placed on top of, or suspended over (e.g., supported by structures 223), a “white” LED 220 (which itself includes a blue LED 221 covered by a wavelength-conversion phosphor material 222, wherein the phosphor material is considered part of the “white” LED 220, and wherein phosphor material 222 converts some of the blue-wavelength light having wavelengths in a wavelength range of about 400 nm to about 500 nm (in some embodiments, within a narrower range of 440 nm to 460 nm) from the blue LED 221 into yellow-wavelength light in a wavelength range between 500 nm and 700 nm, centered at about 580 nm, in some embodiments), with additional laser-excitation light 282 into SCP plate 210A from the front side (the top in FIG. 2A) of SCP plate 210A. LED 220 is mounted to heatsink 225 to help remove heat from LED 220. The white-light output 291 of the LED 220, which includes unconverted blue-wavelength LED light and yellow, wavelength-converted, light from phosphor 222 of LED 220, passes through SCP plate 210A, wherein the yellow light will pass through the SCP with little or no loss, since SCP plate 210A is transparent to yellow light. On the other hand, the unconverted blue light from LED 220 will be partially absorbed by SCP210A and emitted as wavelength-converted yellow light. As a result of the LED light 291 passing into and through SCP plate 210A, the total yellow-light portion of the output from LED 220 is increased by wavelength-conversion in SCP plate 210A, while the blue-light portion of the output from LED 220 is reduced. When the front-side blue-light laser beam 282 is incident on SCP plate 210A, some of the blue laser light is absorbed by SCP plate 210A and converted into yellow light. A small amount of blue light 282 will pass through SCP plate 210A and will be absorbed by phosphor layer 222 of white LED 220, and will be re-emitted as yellow light. The final LED output light 291 of this laser-assisted LED 220 includes yellow light from the original white LED 220, yellow light from the laser-excited SCP plate 210A, and yellow wavelength-converted light from the residue laser light absorbed at the phosphor layer 222 of the white LED 220. In addition, the final output light 299 also includes residual blue light from white LED 220 that is not absorbed by SCP plate 210A, and the portion of blue laser light 282 that is back-scattered from SCP plate 210A. In some embodiments, to provide the desired output and color temperature of the output light 299, the amount of unconverted blue light from white LED 220 and the amount of blue light from laser beam 282 that is back-scattered from SCP plate 210A, are adjusted (such as by adjusting a thickness of the phosphor material layer 222 on white LED 220, or adjusting the density of phosphors in phosphor material layer 222 and SCP plate 210A). In some embodiments, one or more side support structures 223 that are made of a material having a high thermal conductivity, such as copper, silver or other suitable material, support SCP plate 210A above (or in contact with) LED 220 and help conduct heat to heatsink 225.

Continuing, the embodiments shown in FIGS. 2B, 2C, and 2D are top views of various embodiments of devices having the cross-section shown in FIG. 2A, which show a partial coverage of the white LED emission area by SCP plates of three different optional shapes of the SCP plate. The laser-assist excitation (i.e., one or more laser beams 294 from one or more blue lasers, or a scanned laser beam that is moved across the SCP) is directed towards one or more spots or locations on the top surface of the SCP plate (i.e., 210A, 210B, 210C or 210D) within the perimeter of the emission area of the white LED 220.

FIG. 2B is a top-view a combined LED and laser-pumped crystal-phosphor-plate light source 202, according to some embodiments of the present invention. In some embodiments, light source 202 includes SCP plate 210B that is a narrow strip of SCP plate covering part of white LED 220 (e.g., in some embodiments, a central portion of the white LED), as shown in FIG. 2B.

FIG. 2C is a top-view a combined LED and laser-pumped crystal-phosphor-plate light source 203, according to some embodiments of the present invention. In some embodiments, SCP plate 210C covers part of the LED and has one or more circular or elliptical apertures (e.g., curved holes through which some of the light from the white LED is emitted), as shown in FIG. 2C.

FIG. 2D is a top-view a combined LED and laser-pumped crystal-phosphor-plate light source 204, according to some embodiments of the present invention. In some embodiments, SCP plate 210D covers part of the LED and has one or more rectangular holes through which some of the light from the white LED is emitted, as shown in FIG. 2D.

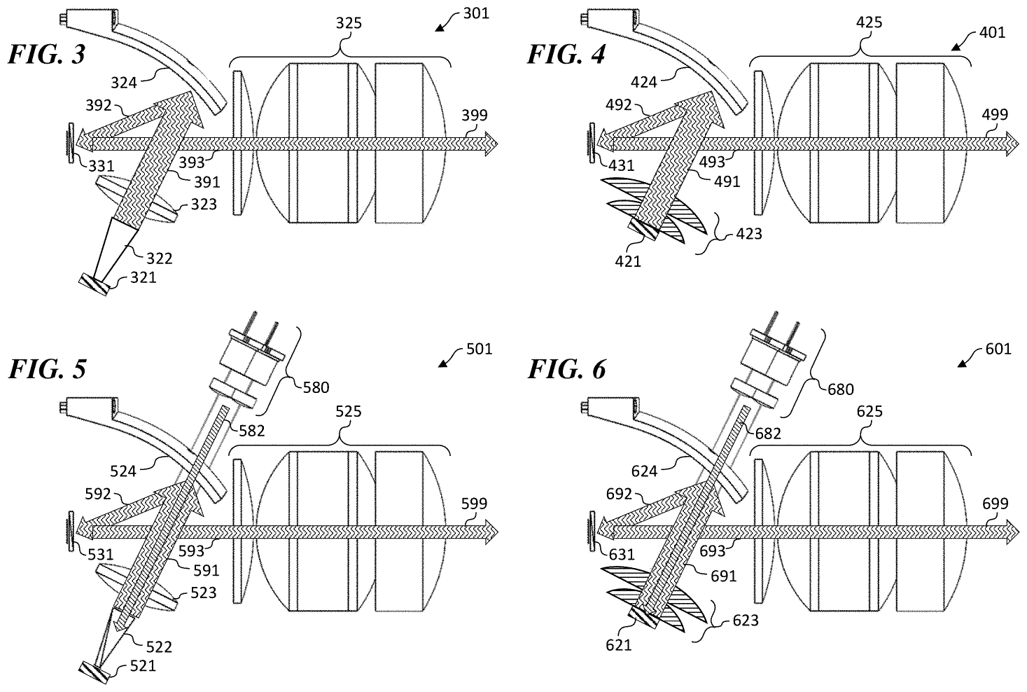

FIG. 3 is a side cross-section view of a DMD headlight 301 that uses a high-power white LED light source 321, according to some embodiments of the present invention. In some embodiments, DMD headlight 301 includes white LED 321 coupled through a tapered light pipe 322 (also called a tapered light tunnel) and a condensing lens 323 to form beam 391, then reflected by a concave mirror 324 as beam 392 towards a DMD (digital micromirror device) 331. DMD 331, which includes one or more micromirrors, each of which selectively reflects toward the output as beam 392 (in ON position) or reflects toward a light dump (in OFF position—see for example, FIGS. 11 and 12), and thus modulates the shape of reflected beam 393, which is then focused by projection lens 325 and projected as output beam 399 (e.g., in some embodiments, used as a headlight beam). As each micromirror of DMD 331 is rotated to one or another of its angular positions, the corresponding pixel in the beam 393 is turned ON or OFF, and beam 393 is directed through the output projection lens 325, with the desired pattern being projected onto the roadway as shaped output beam 399. In some embodiments, the shaped output beam 399 is used as an adaptive-driving-beam (ADB) (computer-controlled “smart” headlight) for a vehicle. In some other embodiments, other light-coupling systems, including multiple lenses 423 without a tapered light pipe, are used, as shown in FIG. 4.

FIG. 4 is a side cross-section view of a DMD headlight 401 that uses a high-power white LED light source 421, according to some embodiments of the present invention. In some embodiments, DMD headlight 401 includes white LED 421 coupled through a condensing lens 423, then reflected by a concave mirror 424 towards DMD 431. DMD 431 selectively reflects beam 492, thus modulating the shape and amount of reflected beam 493, which is then focused by projection lens 425 and projected as output beam 499. In some embodiments, the shaped output beam 499 is used as an ADB headlight for a vehicle. To enhance the LED output, some embodiments use a Laser-Assist™ LED system, as shown in FIG. 5.

FIG. 5 is a side cross-section view of a DMD headlight 501 that uses a combined LED and laser-pumped crystal-phosphor plate light source 521, according to some embodiments of the present invention. In some embodiments, DMD headlight 501 includes SCP-and-white-LED structure 521 (e.g., such as those shown in FIGS. 2A, 2B, 2C, and/or 2D) that includes a white LED and a single-crystal phosphor (SCP) plate that is pumped by a blue laser beam 582 generated by laser 580, which is directed through a small aperture in concave mirror 524, and through tapered light tunnel 522 onto SCP-and-white-LED structure 521. In various embodiments, one or more laser diodes are used, depending on the amount of light desired (with more lasers producing more light). Thus, in some embodiments, two laser diodes are packaged together in laser assembly 580, and used as the excitation light sources, with beam 582 including the output of both laser diodes, and being directed towards SCP-and-white-LED structure 521 through an aperture in concave reflector 524. In some embodiments, an optional coupling lens 523 is included such that the desired laser-light profile is obtained at SCP-and-white-LED structure 521. In one embodiment, the laser light 582 is focused onto the SCP (e.g., SCP 210A, 210B, 210C or 210D of FIGS. 2A-2D) of SCP-and-white-LED structure 521, providing a hot spot in the output beam 599. In some embodiments, the laser light 582 is selectively (in some embodiments, via a computer-controlled focusing of lens 523) (or non-selectively) slightly defocused such that the SCP is excited with a more uniform laser excitation. The combined output from both the white LED portion and the laser-excited SCP portion of SCP-and-white-LED structure 521 is directed towards the DMD 531, increasing the total light of output beam 599 projected onto the roadway. In one embodiment, using two laser diodes, a crystal phosphor plate, and a white Nichia® LED, a 50% increase in light output has been obtained.

In some embodiments, output white light from SCP-and-white-LED structure 521 is coupled through tapered light tunnel 522 and condensing lens 523 to form beam 591, which is then reflected by a concave mirror 524 as beam 592 towards DMD 531. DMD 531 includes one or more micromirrors, each of which selectively reflects toward the output as beam 592 (in ON position) or reflects toward a light dump—not shown (in OFF position—see for example, FIGS. 11 and 12), and thus modulates the shape of reflected beam 593, which is then focused by projection lens 525 and projected as output beam 599. As each micromirror of DMD 531 is rotated to one or another of its angular positions, the corresponding pixel in the beam 593 is turned ON or OFF. Beam 593 is directed through the output projection lens 525 and the desired pattern is projected, e.g., onto the roadway as shaped output beam 599. In some embodiments, the shaped output beam 399 is used as an adaptive-driving-beam (ADB) (computer-controlled “smart” headlight) for a vehicle. In some other embodiments, other light-coupling systems, including multiple lenses 623 without a tapered light pipe, are used, as shown in FIG. 6.

FIG. 6 is a side cross-section view of a DMD headlight 601 that uses a combined LED and laser-pumped crystal-phosphor plate light source 621, according to some embodiments of the present invention. In some embodiments, DMD headlight 601 includes SCP-and-white-LED structure 621 (substantially similar to structures 521, 421, or 321) pumped by a blue laser beam 682 generated by laser 680, which is directed through a small aperture in concave mirror 624, and through condensing lens 623 onto SCP-and-white-LED structure 621. In various embodiments, one or more laser diodes are used in laser 680, depending on the amount of light desired (with more lasers producing more light). In some embodiments, two laser diodes are packaged together in laser assembly 680 and used as the excitation light sources, with beam 682 including the output of both laser diodes, and being directed towards SCP-and-white-LED structure 621 through an aperture in concave reflector 624. In some embodiments, condensing lens 623 is included to form the desired laser-light profile at SCP-and-white-LED structure 621. In one embodiment, laser light 683 is focused onto the SCP portion of SCP-and-white-LED structure 621, providing a hot spot in the output beam 699. In some embodiments, laser light 691 is selectively (in some embodiments, via a computer-controlled focusing of lens 623) (or non-selectively) slightly defocused such that the SCP is excited with a more uniform laser excitation. The combined output from the white LED portion and the laser-excited SCP portion of SCP-and-white-LED structure 621 is directed towards the DMD 631, increasing the total output 699 projected onto the roadway. In the embodiment shown in FIG. 6, blue laser light 682 is focused onto the Laser-Assist™ LED 621 directly. Since the surface intensity is directly imaged onto DMD 631 through condenser lenses 623 and concave mirror 624, the intensity profile created by the laser onto the Laser Assist™ LED will be the intensity profile on the DMD. As a result, a non-uniform intensity profile can be created, such as a hot spot, which profile permits better flexibility and efficiency for the DMD headlight.

Laser-Assist LED for High-Power ADB Automotive Headlight

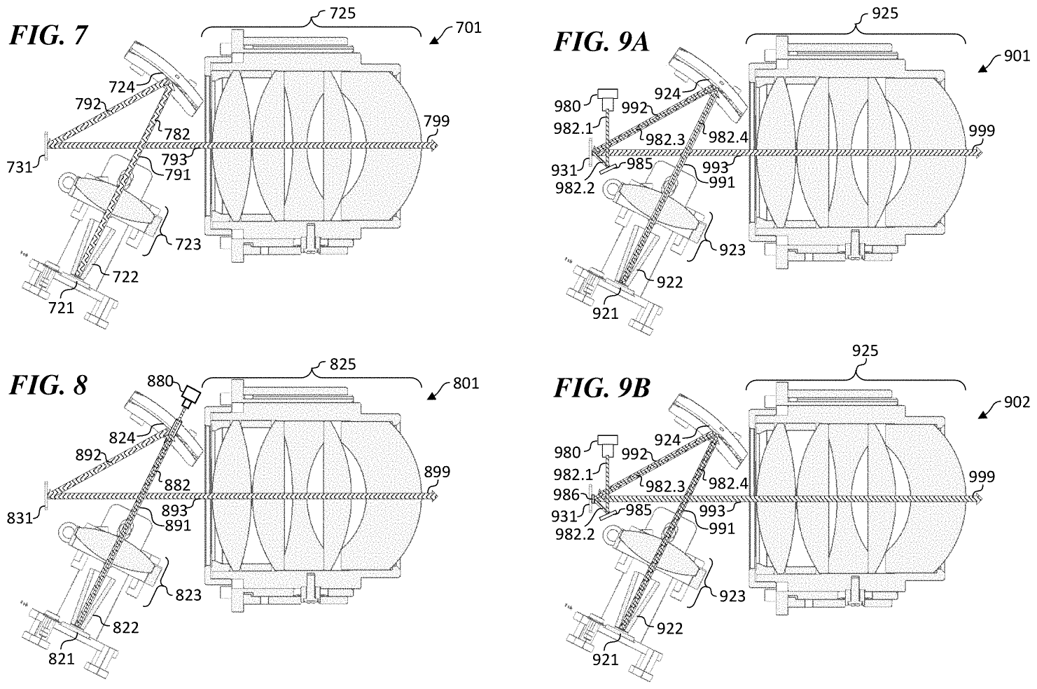

FIG. 7 is a side cross-section view of an Adaptive-driving-beam (ADB) headlight 701 that uses an LED light source 721, according to some embodiments of the present invention. FIG. 7 shows ADB 701 that uses high-brightness LED 721 as a light source. The output of LED 721 is coupled to DMD 731 through a light tunnel 722, a condensing lens 723, and a concave reflector 724, which are optimized to provide a light profile, at the DMD 731, to be as close to the DMD size and shape as possible for efficient coupling. The reflected light 793 from the DMD pixels is directed toward the projection lens 725 when the pixels are ON, and to a light dump (not shown) when the pixels are OFF. By controlling each pixel mirror of DMD 731, various light patterns of output light 799 can be projected onto the roadway, including low beam, high beam, ultra-long-range beam, text, symbols, etc.

FIG. 8 is a side cross-section view of a DMD headlight 801 that uses a combined LED and laser-pumped crystal-phosphor plate light source 821, according to some embodiments of the present invention. As shown in FIG. 8, additional output intensity can be obtained by adding one or more blue laser beams from laser(s) 880 directed towards the crystal-phosphor portion of combined LED and laser-pumped crystal-phosphor plate light source 821 through one or more apertures at the concave reflector 824. The laser-beam excitations of the phosphor will produce additional white light, which is coupled to the DMD 831 the same way light output from the LED portion of combined LED and laser-pumped crystal-phosphor plate light source 821 is.

FIG. 9A is a side cross-section view of a DMD headlight 901 that uses a combined LED and laser-pumped crystal-phosphor plate light source 921, according to some embodiments of the present invention. FIG. 9A shows the implementation of this invention by placing a small reflector 985 at the position of the LED light dump (the location where light from a pixel of DMD 931 is directed, when that pixel is in the OFF position—see FIGS. 11 and 12), which is placed at the 48-degree position relative to the DMD 931. In some embodiments, laser-assist laser beam 982.1 is directed towards reflector 985 and light 982.2 is the reflected light propagating towards DMD 931, which reflects light 982.3 towards curved mirror 924 that redirects beam 982.4 towards combined LED and laser-pumped crystal-phosphor plate light source 921 for additional excitation for increase in brightness.

FIG. 9B is a side cross-section view of a DMD headlight 902 that uses a combined LED and laser-pumped crystal-phosphor plate light source 921, according to some embodiments of the present invention. In some embodiments, DMD headlight 902 is substantially similar to DMD headlight 901, but with the addition of a small highly reflective mirror 986 place in front of the middle of DMD 931 to reflect laser beam 982.2 and thus reduce the heat load on DMD 931. Instead of reflecting laser beam 982.2 off the micro-mirrors on DMD 931, small external mirror 986 is placed on top of DMD 931 to be used as the laser-beam reflector for reflecting laser beam 982.3 to curved mirror 924 and then into the LED 921. This eases the potential thermal problems when using DMD 931 with higher-power laser beams. In some embodiments, a plurality of small mirrors, together with a plurality of laser beams, are used to further increase excitation power delivered to LED 921.

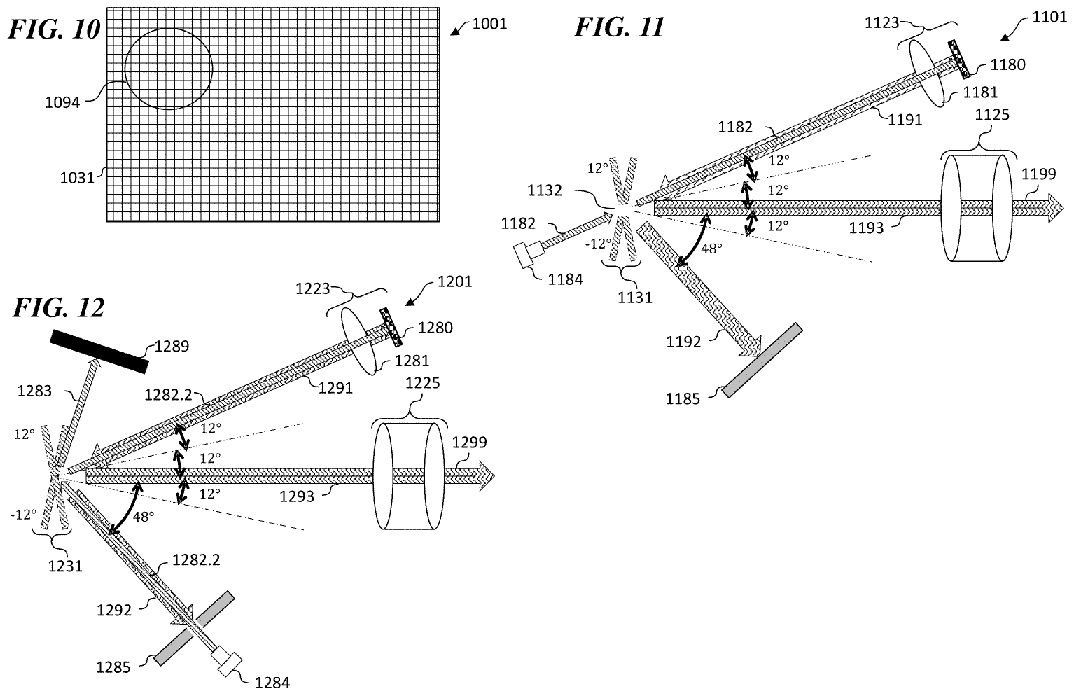

FIG. 10 is a front-view of a DMD 1001, according to some embodiments of the present invention. FIG. 10 shows the relationship of the laser-illumination area 1094 on the DMD 1031 versus the rest of the whole area of the DMD, where this illumination is OFF. In some embodiments, the size of the illuminated area 1084 is controlled, and light projected onto illuminated area 1094 is selectively modulated to the desired pattern.

FIG. 11 is a side cross-section view of a DMD headlight 1101 that uses a combined LED and laser-pumped crystal-phosphor plate light source 1123, according to some embodiments of the present invention. FIG. 11 is a simplified schematic diagram of the system 801 shown in FIG. 8, where in FIG. 11, the concave reflector 824 is removed, showing a straight path from SCP-LED system 1180 to the DMD 1131 (where in this simplified schematic, only a single mirror is shown). DMD headlight 1101 includes light source 1123 having SCP-LED light source 1180 and a condensing lens 1181, and its light 1191 is directed towards the DMD 1131 directly, rather than being reflected by a concave reflector as shown in FIGS. 9A and 9B). The laser-assist beam 1182 from laser 1184 is simply shown as a beam incident at SCP-LED system 1180, producing additional light output without the concave reflector 824 (see FIG. 8) and its aperture. A representative one of the plurality of DMD pixel mirrors are represented with a single-pixel mirror in FIG. 11. When the pixel is ON, the mirror is tilted at 12°, and the light output from the LED is reflected towards the projection lens 1125 as beam 1193. When the pixel is OFF, the mirror is tilted at −12°, and the LED light output is reflected towards the light dump 1185 at 48° and is absorbed there.

FIG. 12 is a side cross-section view of a DMD headlight 1201 that uses a combined LED and laser-pumped crystal-phosphor plate light source 1223, according to some embodiments of the present invention. DMD headlight 1201 includes light source 1223 having SCP-LED light source 1280 and a condensing lens 1281 and its light 1291 is directed towards the DMD 1231 (where only one micromirror is shown here) either directly or reflected by a concave reflector. The beam is directed at an angle of 24° from the optical axis defined by DMD 1231 and projection lens 1225. In some embodiments, DMD 1231 is a pixelated mirror, where each pixel's mirror can be controlled to be in the ON position of 12° and in the OFF position of −12°. The diagram shows one pixel mirror of the many pixels of the DMD 1231. When the pixel is on the ON position, beam 1291 is reflected as beam 1293 towards the projection lens 1225 and finally output as beam 1299. Thus, light reflected by the pixel of DMD 1231 will be projected as output beam 1299 onto the target. Various projected patterns can be constructed by controlling the appropriate pixels of DMD 1231 at the appropriate time instances. When the respective pixel is in the OFF position, i.e., −12° (when the pixel is not contributing to beam 1293), the light will be reflector towards the LED light dump 1285, which is at a position of −48°. Various projected patterns can be constructed by turning the appropriate pixels of DMD 1231 ON and OFF at the appropriate time instances. In order to provide additional excitation to the LED utilizing the OFF position of the pixel of DMD 1231 at −12°, in some embodiments, the laser-assist input is placed at the −48° position such that the laser beam is directed towards the SCP-LED light source 1280, which is located at +24°, increasing the output of SCP-LED light source 1280. In some embodiments, this laser excitation is mixed by the light tunnel (not shown here) located adjacent SCP-LED light source 1280, and will be substantially uniform at SCP-LED light source 1280 with laser-excited light output substantially the same as the original LED output, and will be coupled to illuminate the full area of DMD 1231. Since the laser-excited area is in the area of DMD 1231 where pixels are in the OFF position, the projected output 1299 will be dark in this area. The rest of the projected areas of output 1299 will be brighter. If laser illumination, for some reason, happens to be directed onto certain ON pixels, the light will be reflected away from the direction of the LED and absorbed by the laser light dump 1289.

In some embodiments, the present invention provides an apparatus including an adaptive-driving-beam (ADB) headlight device that includes: a digital micromirror device (DMD) that includes one or more micromirrors; a white LED having an emission area configured to output at least a portion of a first light beam; a curved mirror configured to reflect and focus the first light beam to form a second light beam directed towards the DMD, wherein the DMD selectively reflects light of the second beam as a modulated third beam; and a projection lens configured to receive the modulated third beam and to focus light of the modulated third beam and project a resulting output beam, in order to provide increased field of view (FOV) and headlight brightness.

Some embodiments of the apparatus, such as shown in FIGS. 3, 5, 7, 8, 9A, and 9B, further include a tapered light tunnel configured to guide emitted light of first light beam toward the curved mirror.

Some embodiments of the apparatus, such as shown in FIGS. 3, 4, 5, 6, 7, 8, 9A, and 9B, further include a condensing lens configured to receive and focus light of the first light beam toward the curved mirror.

Some embodiments, such as shown in FIGS. 5, 6, 8, 9A, and 9B, further include a single-crystal-phosphor (SCP) plate mounted over at least a portion of the emission area of the white LED; and at least one laser that emits a blue laser beam that impinges on the SCP plate such that the SCP plate wavelength converts at least some of the light of the blue laser beam and at least some of the light of the white LED to longer wavelengths than wavelengths of the light of the blue laser beam and the light of the white LED, wherein the first light beam includes light from the SCP and the white LED.

Some embodiments, such as shown in FIGS. 5, 6, 7, 8, 9A, and 9B, further include a single-crystal-phosphor (SCP) plate mounted over at least a portion of the emission area of the white LED; at least one laser that emits a blue laser beam that impinges on the SCP plate such that the SCP plate wavelength converts at least some of the light of the blue laser beam and at least some of the light of the white LED to longer wavelengths than wavelengths of the light of the blue laser beam and the light of the white LED; and a tapered light tunnel configured to receive and guide the blue laser beam toward the SCP plate and to guide emitted light of first light beam toward the curved mirror, wherein the first light beam includes light from the SCP and the white LED.

Some embodiments, such as shown in FIGS. 5, 8, 9A, and 9B, further include a single-crystal-phosphor (SCP) plate mounted over at least a portion of the emission area of the white LED; at least one laser that emits a blue laser beam that impinges on the SCP plate such that the SCP plate wavelength converts at least some of the light of the blue laser beam and at least some of the light of the white LED to longer wavelengths than wavelengths of the light of the blue laser beam and the light of the white LED; a tapered light tunnel configured to receive and guide the blue laser beam toward the SCP plate and to guide emitted light of first light beam toward the curved mirror, wherein the first light beam includes light from the SCP and the white LED; and a condensing lens positioned adjacent the tapered light tunnel and configured to receive and focus the blue laser beam through the tapered light tunnel toward the SCP plate and to focus emitted light of first light beam from the tapered light tunnel toward the curved mirror, wherein the first light beam includes light from the SCP and the white LED.

Some embodiments, such as shown in FIG. 6, further include a single-crystal-phosphor (SCP) plate mounted over at least a portion of the emission area of the white LED; at least one laser that emits a blue laser beam that impinges on the SCP plate such that the SCP plate wavelength converts at least some of the light of the blue laser beam and at least some of the light of the white LED to longer wavelengths than wavelengths of the light of the blue laser beam and the light of the white LED; and a condensing lens positioned adjacent the SCP plate and configured to receive and focus the blue laser beam t toward the SCP plate and to focus emitted light of first light beam from the SCP plate and the white LED toward the curved mirror, wherein the first light beam includes light from the SCP and the white LED.

Some embodiments, (not shown) further include a vehicle, wherein the ADB headlight device is mounted to the vehicle, and the output beam is used as a headlight beam for the vehicle, to provide increased field of view (FOV) and headlight brightness.

In some embodiments, the present invention provides a method for generating an output beam, the method including providing a digital micromirror device (DMD) that includes one or more micromirrors, a white LED having an emission area configured to output at least a portion of a first light beam; reflecting and focusing the first light beam to form a second light beam directed towards the DMD; operating the DMD to selectively reflect light of the second beam as a modulated third beam; and focusing the modulated third beam and projecting light of the modulated third beam as an output beam.

Some embodiments of the method further include: providing a tapered light tunnel; and using the tapered light tunnel to guide light of first light beam toward the curved mirror.

Some embodiments of the method further include: focusing light of the first light beam toward the curved mirror.

Some embodiments of the method further include: providing a single-crystal-phosphor (SCP) plate; mounting the SCP plate over at least a portion of the emission area of the white LED; providing at least one blue laser beam; and directing the at least one blue laser beam onto the SCP plate such that the SCP plate wavelength converts at least some of the light of the blue laser beam and at least some of the light of the white LED to longer wavelengths than wavelengths of the light of the blue laser beam and the light of the white LED, wherein the first light beam includes light from the SCP and the white LED.

Some embodiments of the method further include: providing a single-crystal-phosphor (SCP) plate; mounting the SCP plate over at least a portion of the emission area of the white LED; providing at least one laser that emits a blue laser beam; directing the blue laser beam onto the SCP plate such that the SCP plate wavelength converts at least some of the light of the blue laser beam and at least some of the light of the white LED to longer wavelengths than wavelengths of the light of the blue laser beam and the light of the white LED; providing a tapered light tunnel; and using the tapered light tunnel to guide the blue laser beam toward the SCP plate and to guide emitted light of first light beam toward the curved mirror, wherein the first light beam includes light from the SCP and the white LED.

Some embodiments of the method further include: providing a single-crystal-phosphor (SCP) plate; mounting the SCP plate over at least a portion of the emission area of the white LED; providing at least one laser that emits a blue laser beam; directing the blue laser beam onto the SCP plate such that the SCP plate wavelength converts at least some of the light of the blue laser beam and at least some of the light of the white LED to longer wavelengths than wavelengths of the light of the blue laser beam and the light of the white LED; providing a tapered light tunnel; using the tapered light tunnel to guide the blue laser beam toward the SCP plate and to guide emitted light of first light beam toward the curved mirror, wherein the first light beam includes light from the SCP and the white LED; and focusing the blue laser beam through the tapered light tunnel toward the SCP plate and focusing emitted light of first light beam from the tapered light tunnel toward the curved mirror, wherein the first light beam includes light from the SCP and the white LED.

Some embodiments of the method further include: providing a single-crystal-phosphor (SCP) plate; mounting the SCP plate over at least a portion of the emission area of the white LED; providing at least one laser that emits a blue laser beam; directing the blue laser beam onto the SCP plate such that the SCP plate wavelength converts at least some of the light of the blue laser beam and at least some of the light of the white LED to longer wavelengths than wavelengths of the light of the blue laser beam and the light of the white LED; and focusing the blue laser beam toward the SCP plate and focusing emitted light from the SCP and the white LED toward the curved mirror, wherein the first light beam includes light from the SCP and the white LED.

Some embodiments of the method further include: providing a vehicle; and using the output beam as a headlight beam for the vehicle, to provide increased field of view (FOV) and headlight brightness.

In some embodiments, the present invention provides an apparatus for generating an output beam, the apparatus including: a digital micromirror device (DMD) that includes one or more micromirrors; a white LED having an emission area configured to output at least a portion of a first light beam; means for reflecting and focusing the first light beam to form a second light beam directed towards the DMD; means for operating the DMD to selectively reflect light of the second beam as a modulated third beam; and means for focusing the modulated third beam and projecting light of the modulated third beam as an output beam.

Some embodiments of the apparatus, such as shown in FIGS. 3, 5, 7, 8, 9A, and 9B, further include a tapered light tunnel used to guide light of first light beam toward the curved mirror. Some embodiments of the apparatus, such as shown in FIGS. 3, 4, 5, 6, 8, 9A, and 9B, further include means for focusing light of the first light beam toward the curved mirror. Some embodiments of the apparatus, such as shown in FIGS. 5, 6, 7, 8, 9A, and 9B, further include a single-crystal-phosphor (SCP) plate; means for mounting the SCP plate over at least a portion of the emission area of the white LED; means for generating at least one blue laser beam; and means for directing the at least one blue laser beam onto the SCP plate such that the SCP plate wavelength converts at least some of the light of the blue laser beam and at least some of the light of the white LED to longer wavelengths than wavelengths of the light of the blue laser beam and the light of the white LED, wherein the first light beam includes light from the SCP and the white LED.

It is to be understood that the above description is intended to be illustrative, and not restrictive. Although numerous characteristics and advantages of various embodiments as described herein have been set forth in the foregoing description, together with details of the structure and function of various embodiments, many other embodiments and changes to details will be apparent to those of skill in the art upon reviewing the above description. The scope of the invention should be, therefore, determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

What is claimed is:

1. An apparatus comprising
an adaptive-driving-beam (ADB) headlight device that includes:
a digital micromirror device (DMD) that includes one or more micromirrors;
a white LED having an emission area configured to output at least a portion of a first light beam;
a curved mirror configured to reflect and focus the first light beam to form a second light beam directed towards the DMD, wherein the DMD selectively reflects light of the second beam as a modulated third beam; and
a projection lens configured to receive the modulated third beam and to focus light of the modulated third beam and project a resulting output beam.

2. The apparatus of claim 1, further including:
a tapered light tunnel configured to guide emitted light of first light beam toward the curved mirror.

3. The apparatus of claim 1, further including:
a condensing lens configured to receive and focus light of the first light beam toward the curved mirror.

4. The apparatus of claim 1, further including:
a single-crystal-phosphor (SCP) plate mounted over at least a portion of the emission area of the white LED; and
at least one laser that emits a blue laser beam that impinges on the SCP plate such that the SCP plate wavelength converts at least some of the light of the blue laser beam and at least some of the light of the white LED to longer wavelengths than wavelengths of the light of the blue laser beam and the light of the white LED, wherein the first light beam includes light from the SCP and the white LED.

5. The apparatus of claim 1, further including:
a single-crystal-phosphor (SCP) plate mounted over at least a portion of the emission area of the white LED;
at least one laser that emits a blue laser beam that impinges on the SCP plate such that the SCP plate wavelength converts at least some of the light of the blue laser beam and at least some of the light of the white LED to longer wavelengths than wavelengths of the light of the blue laser beam and the light of the white LED; and
a tapered light tunnel configured to receive and guide the blue laser beam toward the SCP plate and to guide emitted light of first light beam toward the curved mirror, wherein the first light beam includes light from the SCP and the white LED.

6. The apparatus of claim 1, further including:
a single-crystal-phosphor (SCP) plate mounted over at least a portion of the emission area of the white LED;
at least one laser that emits a blue laser beam that impinges on the SCP plate such that the SCP plate wavelength converts at least some of the light of the blue laser beam and at least some of the light of the white LED to longer wavelengths than wavelengths of the light of the blue laser beam and the light of the white LED;
a tapered light tunnel configured to receive and guide the blue laser beam toward the SCP plate and to guide emitted light of first light beam toward the curved mirror, wherein the first light beam includes light from the SCP and the white LED; and
a condensing lens positioned adjacent the tapered light tunnel and configured to receive and focus the blue laser beam through the tapered light tunnel toward the SCP plate and to focus emitted light of first light beam from the tapered light tunnel toward the curved mirror, wherein the first light beam includes light from the SCP and the white LED.

7. The apparatus of claim 1, further including:
a single-crystal-phosphor (SCP) plate mounted over at least a portion of the emission area of the white LED;
at least one laser that emits a blue laser beam that impinges on the SCP plate such that the SCP plate wavelength converts at least some of the light of the blue laser beam and at least some of the light of the white LED to longer wavelengths than wavelengths of the light of the blue laser beam and the light of the white LED; and
a condensing lens positioned adjacent the SCP plate and configured to receive and focus the blue laser beam t toward the SCP plate and to focus emitted light of first light beam from the SCP plate and the white LED toward the curved mirror, wherein the first light beam includes light from the SCP and the white LED.

8. The apparatus of claim 1, further including:
a vehicle, wherein the ADB headlight device is mounted to the vehicle, and the output beam is used as a headlight beam for the vehicle, to provide increased field of view (FOV) and headlight brightness.

9. A method for generating an output beam, the method comprising
providing a digital micromirror device (DMD) that includes one or more micromirrors, a white LED having an emission area configured to output at least a portion of a first light beam;
reflecting and focusing the first light beam to form a second light beam directed towards the DMD;
operating the DMD to selectively reflect light of the second beam as a modulated third beam; and
focusing the modulated third beam and projecting light of the modulated third beam as an output beam.

10. The method of claim 9, further including:
providing a tapered light tunnel; and
using the tapered light tunnel to guide light of first light beam toward the curved mirror.

11. The method of claim 9, further including:
focusing light of the first light beam toward the curved mirror.

12. The method of claim 9, further including:
providing a single-crystal-phosphor (SCP) plate;
mounting the SCP plate over at least a portion of the emission area of the white LED;
providing at least one blue laser beam; and
directing the at least one blue laser beam onto the SCP plate such that the SCP plate wavelength converts at least some of the light of the blue laser beam and at least some of the light of the white LED to longer wavelengths than wavelengths of the light of the blue laser beam and the light of the white LED, wherein the first light beam includes light from the SCP and the white LED.

13. The method of claim 9, further including:
providing a single-crystal-phosphor (SCP) plate;
mounting the SCP plate over at least a portion of the emission area of the white LED;
providing at least one laser that emits a blue laser beam;
directing the blue laser beam onto the SCP plate such that the SCP plate wavelength converts at least some of the light of the blue laser beam and at least some of the light of the white LED to longer wavelengths than wavelengths of the light of the blue laser beam and the light of the white LED;
providing a tapered light tunnel; and
using the tapered light tunnel to guide the blue laser beam toward the SCP plate and to guide emitted light of first light beam toward the curved mirror, wherein the first light beam includes light from the SCP and the white LED.

14. The method of claim 9, further including:
providing a single-crystal-phosphor (SCP) plate;
mounting the SCP plate over at least a portion of the emission area of the white LED;
providing at least one laser that emits a blue laser beam;
directing the blue laser beam onto the SCP plate such that the SCP plate wavelength converts at least some of the light of the blue laser beam and at least some of the light of the white LED to longer wavelengths than wavelengths of the light of the blue laser beam and the light of the white LED;
providing a tapered light tunnel;
using the tapered light tunnel to guide the blue laser beam toward the SCP plate and to guide emitted light of first light beam toward the curved mirror, wherein the first light beam includes light from the SCP and the white LED; and
focusing the blue laser beam through the tapered light tunnel toward the SCP plate and focusing emitted light of first light beam from the tapered light tunnel toward the curved mirror, wherein the first light beam includes light from the SCP and the white LED.

15. The method of claim 9, further including:
providing a single-crystal-phosphor (SCP) plate;
mounting the SCP plate over at least a portion of the emission area of the white LED;
providing at least one laser that emits a blue laser beam;
directing the blue laser beam onto the SCP plate such that the SCP plate wavelength converts at least some of the light of the blue laser beam and at least some of the light of the white LED to longer wavelengths than wavelengths of the light of the blue laser beam and the light of the white LED; and
focusing the blue laser beam toward the SCP plate and focusing emitted light from the SCP and the white LED toward the curved mirror, wherein the first light beam includes light from the SCP and the white LED.

16. The method of claim 9, further including:
providing a vehicle; and
using the output beam as a headlight beam for the vehicle, to provide increased field of view (FOV) and headlight brightness.

17. An apparatus for generating an output beam, the apparatus comprising
a digital micromirror device (DMD) that includes one or more micromirrors;
a white LED having an emission area configured to output at least a portion of a first light beam;
means for reflecting and focusing the first light beam to form a second light beam directed towards the DMD;
means for operating the DMD to selectively reflect light of the second beam as a modulated third beam; and
means for focusing the modulated third beam and projecting light of the modulated third beam as an output beam.

18. The apparatus of claim 17, further including:
a tapered light tunnel used to guide light of first light beam toward the curved mirror.

19. The apparatus of claim 17, further including:
means for focusing light of the first light beam toward the curved mirror.

20. The apparatus of claim 17, further including:
a single-crystal-phosphor (SCP) plate;
means for mounting the SCP plate over at least part of the emission area of the white LED;
means for generating at least one blue laser beam; and
means for directing the at least one blue laser beam onto the SCP plate such that the SCP plate wavelength converts at least some of the light of the blue laser beam and at least some of the light of the white LED to longer wavelengths than wavelengths of the light of the blue laser beam and the light of the white LED, wherein the first light beam includes light from the SCP and the white LED.
